(19) United States
(12) Patent Application Publication
(10) Pub. No.: US 2011/0153469 A1
(43) Pub. Date: Jun. 23, 2011

(54) SYSTEM AND METHOD FOR MANAGING MOBILE INVENTORY WITHIN A VIRTUAL WAREHOUSE

(76) Inventors: Patricia Denise Mackenzie, Clifton Park, NY (US); John William Carbone, Niskayuna, NY (US); Robert August Graziano, Schenectady, NY (US); Kevin Chcan, Jersey City, NJ (US); Andrew John Calver, Marina del Rey, CA (US); Kimberly Marie Mangino, Niskayuna, NY (US)

(21) Appl. No.: 12/646,357

(22) Filed: Dec. 23, 2009

(51) Int. Cl. G06Q 10/00; G08B 13/14; G06Q 50/00; G01N 19/10

(52) U.S. Cl. 705/28; 340/572.1; 705/338; 701/300; 73/29.02

(57) ABSTRACT

A system is provided for managing mobile inventory within a virtual warehouse. The system includes mobile units, each configured to house a respective portion of the mobile inventory. The system further includes communication devices, each configured to collect respective data relating to the portion of the mobile inventory within each mobile unit. Additionally, the system includes a central station in communication with the communication devices, to receive the respective data and to optimize a movement of the mobile inventory within a service area, based on the respective data. The central station is also in communication with a plurality of delivery locations, to receive a delivery request from a respective delivery location of a requested inventory and a requested delivery location, and to determine a movement of the mobile inventory, based on the respective data, respective locations of the mobile units, requested inventory and delivery location.

### BACKGROUND OF THE INVENTION

Structural warehouses are typically used to house inventory. Information is routinely gathered regarding the inventory in the warehouse on a regular basis, to maintain an updated record of the inventory in the warehouse. Such information may include the quantity and the type of inventory within the warehouse, for example. When an order is received at the warehouse, such as from a retail store, the warehouse manager compares the requested quantity and type of inventory on the request order with the warehouse records, to determine if the order can be fulfilled. If the warehouse records indicate that a sufficient quantity of the type of inventory is present in the warehouse, and thus that the order can be fulfilled, a truck or other transport vehicle is loaded with cargo corresponding to the requested inventory, and departs from the warehouse with an “in-transit” mode for the destination.

Once the transport vehicle has departed from the warehouse with the cargo with the “in transit” mode, the warehouse records are modified to remove the ordered inventory, as this inventory has been removed from the warehouse system and is no longer eligible to fulfill future request orders. Although various checkpoints may be established along the route of the transport vehicle during the “in transit” mode, and the time at which the cargo crosses each checkpoint can be reported, the vehicle nevertheless continues to the destination in the “in transit” mode. Delivery services companies such as Fed-ex® and UPS® utilize such a system, and report these crossing times on a website, for example.

It would be advantageous to provide a system for managing inventory which addresses some of the shortcomings of conventional warehouse inventory record keeping, as well as the mode of transporting the inventory to a destination, to provide greater overall flexibility.

### BRIEF DESCRIPTION OF THE INVENTION

In one embodiment of the present invention, a system is provided for managing mobile inventory within a virtual warehouse. The system includes mobile units, each configured to house a respective portion of the mobile inventory. The system further includes units, each unit configured to gather data relating to the respective portion of the mobile inventory. The system further includes position sensors, each position sensor configured to determine a location of the respective mobile unit. The system further includes communication devices, each configured to collect respective data from each unit and respective location data from each position sensor. Additionally, the system includes a central station in communication with the communication devices, to receive the respective data and the respective location data and in further communication with delivery locations of the mobile inventory, to receive a delivery request from a respective delivery location, the delivery request including a requested inventory and a requested delivery location. The central station is configured to determine a movement of the mobile inventory within a service area, based on the respective data, the respective locations of the mobile units, the requested inventory and the requested delivery location.

In another embodiment of the present invention, a system is provided for managing mobile inventory within a virtual warehouse. The system includes one or more mobile unit(s) to house a respective portion of the mobile inventory. The system further includes one or more unit(s) to gather data relating to the respective portion of the mobile inventory, and one or more position sensor(s) to determine a location of a respective mobile unit. Additionally, the system includes one or more communication device(s) to collect the respective data and the respective location from the respective unit and the respective position sensor. A movement of the mobile inventory within a service area is determined, based on the respective data and the respective location. The system also includes a central station in further communication with delivery locations of the mobile inventory, to receive a delivery request from a respective delivery location, the delivery request including a requested inventory and a requested delivery location. The central station is configured to determine a movement of the mobile inventory within a service area, based on the respective data, the respective locations of the mobile units, the requested inventory and the requested delivery location.

In another embodiment of the present invention, a method is provided for managing mobile inventory within a virtual warehouse. The method includes housing a respective portion of the mobile inventory within a respective mobile unit among a plurality of mobile units. The method further includes collecting respective data relating to the portion of the mobile inventory within each mobile unit. The method further includes receiving a delivery request for a requested inventory to a delivery location. The method further includes determining a delivery mobile unit among the plurality of mobile units, based on comparing the respective portion of the mobile inventory with the requested inventory and comparing a transit time of each mobile unit to the delivery location, based on the collecting of the respective data.

### BRIEF DESCRIPTION OF THE DRAWINGS

FIG. 1 is a schematic diagram of an exemplary embodiment of a system for managing mobile inventory within a virtual warehouse in accordance with the present invention;

FIG. 2 is a schematic diagram of a mobile unit within the system illustrated in FIG. 1;

FIG. 3 is a flowchart depicting an exemplary embodiment of a method for managing mobile inventory within a virtual warehouse in accordance with the present invention; and

FIG. 4 is a flowchart depicting an exemplary embodiment of a method for managing mobile inventory within a virtual warehouse in accordance with the present invention.

### DETAILED DESCRIPTION

The exemplary embodiments of the present invention involve the concept of managing the transport of inventory distributed within one or more mobile units, around a service area that may include one or more delivery locations, such as retail stores, for example. In conventional inventory management systems, a delivery request is received from a delivery location, such as a retail store, and the requested inventory is loaded onto a mobile unit, such as a truck trailer, after which the mobile unit departs from the warehouse to the delivery location with a permanent “in-transit” mode. In these conventional systems, once the mobile unit departs from the warehouse for the delivery location with the requested inventory, the mobile unit is in a permanent “in-transit” mode for the delivery location, and cannot be re-routed from this path of travel. However, in reality, various unforeseen scenarios may arise in which the delivery location may no longer need the requested inventory or may develop a need for different inventory other than the initially requested inventory. For example, if a retail store in Florida requests a large quantity of water in anticipation of a hurricane forecast scheduled in the vicinity of the retail store, and yet the eventual hurricane does not pass within a vicinity of the retail store, the retail store may want to cancel or modify the requested water order, and yet this would not be possible with conventional warehouse management systems, if the water has already departed from the warehouse on a truck trailer in an “in-transit” mode. In a similar example, the retail store in Florida may request a quantity of laundry detergent, but after the truck trailer departs from the warehouse with the requested laundry detergent, the hurricane forecast may suddenly develop and indicate the possibility of a hurricane in the vicinity of the store, and necessitate that the order be modified to include a large quantity of water, batteries and can food, for example. However, as previously discussed, none of the conventional inventory management systems would be capable of fulfilling these requests from the delivery locations.

The embodiments of the present invention provide an inventory management system which is capable of modifying delivery order requests, thereby providing greater flexibility to the changing demands and circumstances at each delivery location, in terms of inventory requests. The inventory is distributed among one or more mobile units, and the inventory within each mobile unit may be regularly monitored in terms of quantity/type and other characteristics relating to the inventory, which is then communicated to a central station. Examples of such an arrangement is disclosed in U.S. patent application Ser. No. 11/961,533 filed on Dec. 20, 2007, as well as U.S. patent application Ser. No. 11/861,548 filed on Sep. 26, 2007, both of which are assigned to the assignee of the present application and are incorporated by reference herein. The embodiments of present invention is not limited to the use of truck trailers as mobile units, and includes the use of any land, sea or air vehicles. In one example, a first portion of the mobile inventory may be placed within a first truck trailer, while a second portion of the mobile inventory may be placed within a second truck trailer. Since the first and second truck trailers move within a service area, the inventory is mobile within that service area. Additionally, as discussed in greater detail below, since the truck trailers may conduct their own respective inventory and receive delivery request orders, each truck trailer acts as one piece of a larger virtual warehouse that includes all of the truck trailers.

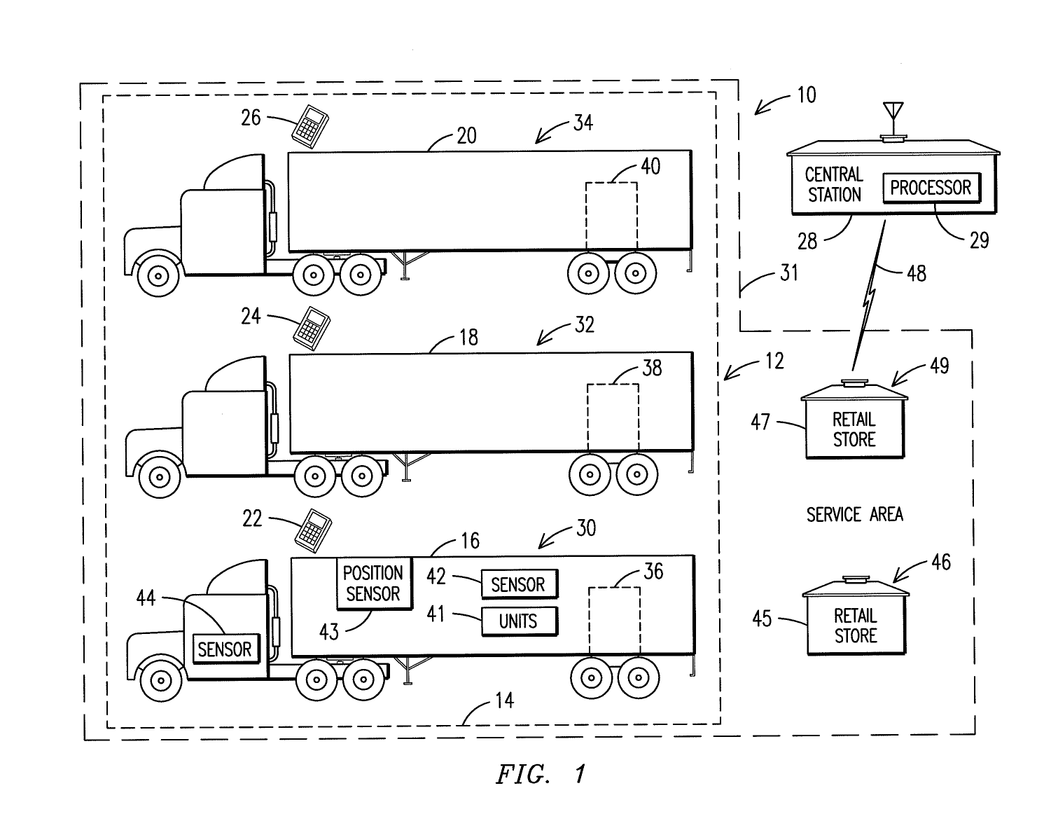

FIG. 1 illustrates an exemplary embodiment of a system 10 for managing mobile inventory 12 within a virtual warehouse 14. As discussed above, the mobile inventory 12 is the collective inventory stored within a plurality of mobile units 16,18,20 that make up the virtual warehouse 14. Although FIG. 1 illustrates three mobile units, less or more than three mobile units may be employed. As illustrated in FIG. 1, the virtual warehouse 14 corresponds to an area occupied by all of the mobile units 16,18,20, and thus varies in area as the mobile units vary their location. In an exemplary embodiment, the mobile units 16,18,20 are trailers being towed by a truck vehicle.

Each mobile unit 16,18,20 houses a respective portion 36,38,40 of the mobile inventory 12. The portions 36,38,40 of the mobile inventory 12 distributed among the mobile units 16,18,20 may be the same type but of varying quantity, the same quantity but of varying type, or of varying quantity and of varying type. The system 10 further includes a plurality of communication devices 22,24,26, where each communication device 22,24,26 is assigned to a respective mobile unit, and each communication device 22,24,26 collects respective data relating to the portion 36,38,40 of the mobile inventory 12 within its respectively assigned mobile unit 16,18,20. For example, as illustrated in FIG. 1, the communication device 22 is assigned to the mobile unit 16, and the communication device 22 is used to collect data regarding the portion 36 of the mobile inventory 12 within the mobile unit 16. In an exemplary embodiment, the communication device may be a handheld communication device, such as a personal digital assistant (PDA) being capable of receiving and transmitting communication over a variety of types of networks.

In an exemplary embodiment, one or more units 41 gather data relating to the respective portion 36 of the mobile inventory 12, including but not limited to one or more of a quantity of the inventory, and a type/brand of the inventory, for example. In an exemplary embodiment, the unit 41 may be a barcode scanner, which is used to scan a barcode or other identifying insignia on an inventory item, to determine the type and/or quantity of the inventory. In addition the units, one or more sensors 42 are used, to gather additional data regarding the respective portion 36 of the mobile inventory 12, including a temperature/humidity in the vicinity of the inventory, a physical condition of the inventory (e.g., packaging), a spoil condition of the inventory (e.g., food), a value of the inventory, and a fragile status of the inventory. Such data from the units 41 and/or the sensors 42 may be automatically inputted into the communication device 22 at regular time intervals, based on the communication device 22 receiving a regular input from the units and/or sensors 42 positioned within the mobile unit 16 and in wireless communication with the communication device 22. For example, a temperature sensor and/or humidity sensor may be positioned within or in a vicinity of the portion 36 of the mobile inventory 12, to measure a temperature/humidity within or in the vicinity of the portion 36 of the mobile inventory 12. Additionally, a pressure sensor may be positioned on or within a packaging of the portion 36 of the mobile inventory 12, to determine if the physical condition of the packaging has been affected. Additionally, a vapor sensor may be positioned in a vicinity of the portion 36 of the mobile inventory 12, particularly food inventory, to detect a presence of a methane gas as being indicative of a current or oncoming spoil condition of the food inventory. The value and fragile status of the portion 36 of the inventory 12 may be pre-programmed into the communication device 22, upon loading the portion 36 of the inventory 12 into the mobile unit 16. Instead of the data being automatically inputted at regular time intervals into the communication device 22, such data may be automatically inputted into the communication device 22, upon a manual input from a driver or worker into the communication device 22. Additionally, such data may be manually inputted, without the use of the sensors discussed above, but instead by the driver or worker manually inputting each piece of data regarding the quantity, type, condition, etc of the portion 36 of the mobile inventory 12.

In addition to the sensors 42 discussed above, which measure parameters relating to the portion 36 of the mobile inventory 12 within the mobile unit 16, one or more sensors 44 measure a parameter related to an operation of the mobile unit 16, such as a tire pressure, an engine parameter, and a vibration of the mobile unit 16, for example. In addition to the data from the sensors 42, the data from the sensors 44 may be regularly inputted to the communication device 22, which is in wireless communication with the sensors 44. As with the sensors 42 discussed above, the data from the sensors 44 may be automatically inputted to the communication device 22 at regular time intervals, automatically inputted to the communication device 22 upon a manual input and/or may be manually inputted to the communication device 22 by a driver and/or worker on the mobile unit 16, after having acquired this data of the parameter relating to the operation of the mobile unit 16.

In addition to the sensors 42,44 and units 41 discussed above, each mobile unit 16,18,20 includes a position sensor 43 which determines a respective location 30,32,34 of the respective mobile unit 16,18,20. For example, the position sensor 43 may be a global position satellite (GPS) sensor, or any sensor configured to measure or determine a current location of the respective mobile unit. The position sensor 43 may automatically transmit the respective location 30,32,34 of the respective mobile unit 16,18,20 to the respective communication device 22,24,26, at the regular time intervals, as discussed above.

As further illustrated in FIG. 1, the system 10 includes a central station 28 in communication with the communication devices 22,24,26, to receive the respective data from each communication device, regarding the respective portion 36,38,40 of the mobile inventory 12 on each respective mobile unit 16,18,20; the location 30,32,34 of the mobile units 16,18,20; and/or the respective parameter relating to the operation of the mobile units 16,18,20. As discussed above, the communication devices 22,24,26 automatically receive this data from the sensors 42,43,44 at regular intervals. Upon receiving this data from the sensors 42,43,44 at the regular intervals, the communication devices 22,24,26 transmit this data to the central station 28. The communication devices 22,24,26 communicate with the central station 28 using one or more of a terrestrial, satellite, and wi-fi network, as appreciated by one of skill in the art.

Although the embodiments discussed above involve the sensors 42,43,44 transmitting their respective data to the communication devices 22,24,26 at a respective time interval, which in-turn transmit this respective data to the central station 28, the sensors 42,43,44 may instead (or in addition) transmit their respective data to the central station 28, thereby bypassing the communication devices 22,24,26.

Based on the received respective data from the communication devices 22,24,26, the central station 28 includes a processor 29 which determines a movement of the mobile inventory 12 within a service area 31. In an exemplary embodiment, the processor 29 may optimize the movement of the mobile inventory 12 within the service area 31, as discussed below. As illustrated in FIG. 1, the service area 31 extends beyond the area of the virtual warehouse 14, as the locations 30,32,34 of the respective mobile units 16,18,20 which constitute the virtual warehouse 14 are mobile to be expanded to various delivery locations within the service area 31, such as retail stores 45,47, for example. In an exemplary embodiment, a service area 31 may include a particular geographic area, such as a county or state, a particular type of inventory such as grocery, or a particular chain of stores, for example.

In an exemplary embodiment, the central station 28 may optimize a movement of the mobile inventory 12 within the service area 31, based on the respective locations 30,32,34 of the mobile units 16,18,20 and the respective portion 36,38,40 of the mobile inventory 12 within each mobile unit 16,18,20. For example, if the respective portions 36,38 of the mobile units 16,18 include significant overlap in terms of either quantity or type of inventory, the central station 28 may transmit a signal to one of the mobile devices 22,24 such that the mobile units 16,18 distribute themselves more evenly throughout the service area 31. Conversely, if the respective portions 36,40 of the mobile units 16,20 do not include significant overlap in terms of either quantity or type of inventory, the central station 28 may transmit a signal to one of the mobile devices 22,26 such that the mobile units 16,20 maintain a closer separation than their present locations 30,34.

In an exemplary embodiment, the central station 28 may optimize a movement of the mobile inventory 12 within the service area 31, based on the respective parameter received from the mobile units 22,24,26. For example, if the central station 28 receives data from the mobile unit 22 that the tire pressure of the truck which is towing the mobile unit 16 is low, the central station 28 may transmit a signal to the mobile unit 22 such that the driver redirects the truck and mobile unit 16 to a service station so that the tire pressure may be corrected to a safe level. Even further, the central station 28 may consider the received value and/or fragile status of the respective portion 36 of the mobile inventory 12, when deciding whether or not the tire pressure has exceeded a safe level. For example, if the respective portion 36 of the mobile unit 12 is plasma televisions having a high value and/or a product having a fragile status, the safety threshold of the tire pressure may be higher than if the respective portion 36 of the mobile unit 12 is produce having a low value and/or no fragile status. If the central station 28 determines that the respective portion 36 of the mobile unit 12 has a high value and the received tire pressure is lower than the safety threshold, the central station 28 may transmit a signal to the communication device 22, requesting that the mobile unit 16 be redirected to the respective location 32 of the mobile unit 18 and that the portion 36 of the mobile inventory 12 on the mobile unit 16 be transferred to the mobile unit 18. Although the above example is discussed with regard to tire pressure, the central station 28 may make such a determination as to any parameter relating to the operation of the mobile unit, including vibration, engine temperature, etc.

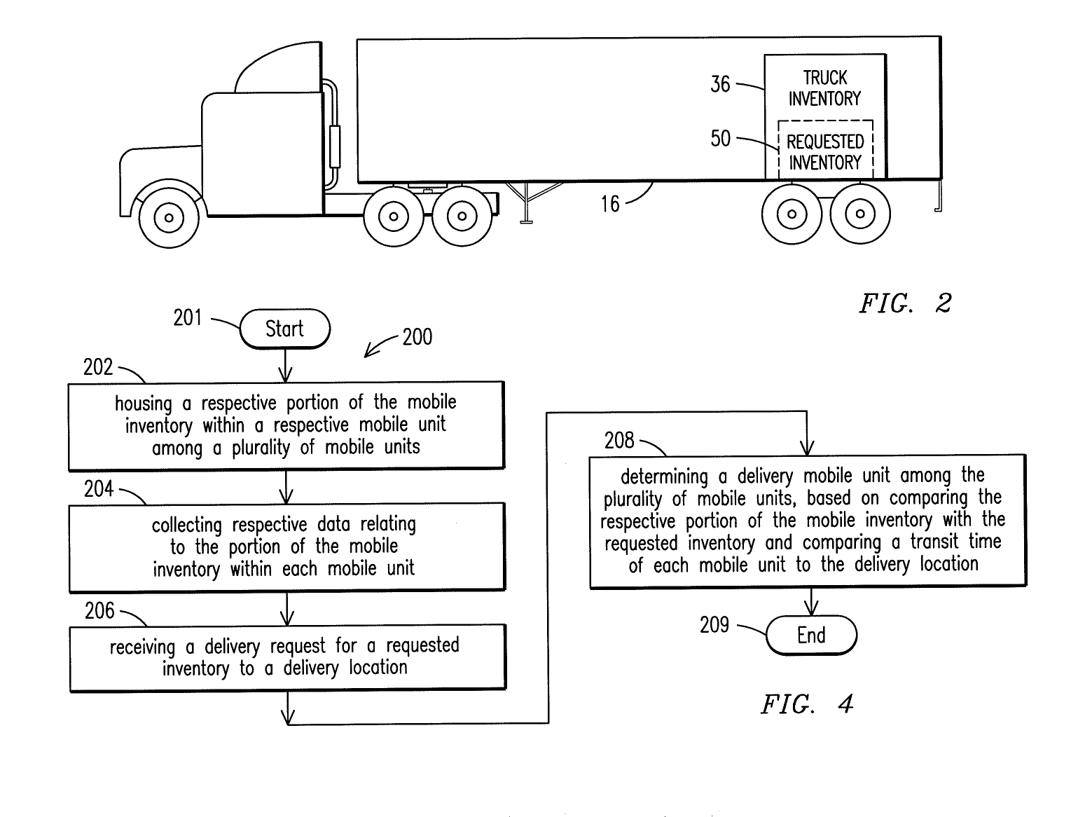

As discussed above, the embodiments of the present invention present an inventory system which is capable of managing the mobile inventory 12, based on one or more inventory requests received from one or more retail stores 45,47 positioned at respective delivery locations 46,49. Although FIG. 1 illustrates retail stores 45,47 positioned at the respective delivery locations 46,49, the embodiments of the present invention are not limited to retail stores, and include any facility which requests a specific inventory to be delivered to a particular location. As illustrated in FIG. 1, the central station 28 receives a signal 48 having a delivery request from the retail store 45 at the delivery location 46, for a requested inventory 50. The delivery locations 46,49 of the retail stores 45,47 may be prestored in a memory of the processor 29 of the central station 28, or may be alternatively transmitted to the central station 28, along with the delivery request. Based on this delivery request, the central station 28 optimizes the movement of the mobile inventory 12 based on one or more of: (1) the respective portion 36,38,40 of the mobile inventory 12 within each mobile unit 16,18,20; (2) the respective location 30,32,34 of each mobile unit 16,18,20; (3) the delivery location 46; and (4) the requested inventory 50. As illustrated in FIG. 2, the central station 28 designates a delivery mobile unit 16 among the plurality of mobile units 16,18,20 to deliver the requested inventory 50 to the deliver location 46 based on: (1) an overlap comparison between the respective portions 36,38,40 of the mobile inventory 12 within the delivery mobile units 16,18,20 and the requested inventory 50; and (2) a proximate comparison of the location 30,32,34 of the delivery mobile units 16,18,20 and the delivery location 46.

As illustrated in FIG. 2, the processor 29 of the central station 28 performs the overlap comparison by determining that the requested inventory 50 coincides with the respective portion 36 of the mobile inventory 12 within the mobile unit 16. The processor 29 may also determine that the requested inventory 50 coincides with the respective portion 38,40 of the mobile inventory 12 within the other mobile units 18,20. For example, if the requested inventory is 40 units of water, the processor 29 determines which of the respective portions 36,38,40 include 40 units of water. Whichever eligible mobile units fulfill this overlap inventory comparison are used in the proximate comparison. In an exemplary embodiment, the processor 29 of the central station 28 also performs the proximate comparison, by determining a minimal travel time between the locations 30,32,34 of the eligible mobile units 16,18,20 and the delivery location 46. To perform this proximate comparison, the processor 29 utilizes the location 30,32,34 data previously received from the respective communication devices 22,24,26, and computes a minimal travel time using historical data. The historical data is based on average transit times between the respective location 30,32,34 and the delivery location 46, as obtained from a database, which may or may not be based on the type/model of the mobile unit, as well as the time and day of the week, for example. As illustrated in FIG. 1, the location 30 of the mobile unit 16 is the most proximate to the delivery location 46, and thus the processor 29 designates the mobile unit 16 as the delivery mobile unit. It should be noted that minimal transit time and minimal distance are not necessarily synonymous, depending on the historical data, but for simplicity in this example, this will be presumed. The central station 28 subsequently transmits a delivery request to the communication device 22, to request that the mobile unit 16 deliver the requested inventory 50 among the respective portion 36, to the delivery location 46.

In an exemplary embodiment, an initial delivery request within the signal 48 from the store 45 at the delivery location 46 to the central station 28 may request large quantities of emergency inventory, such as water, flashlights and/or batteries, based on an upcoming emergency weather forecast at the delivery location 46. At a subsequent time, a second request may be transmitted from the store 45 to the central station 28, to cancel the requested large quantities of emergency inventory, since the emergency weather forecast was redirected from the delivery location 46 to the delivery location 49. Based on the emergency weather forecast being redirected to the delivery location 49, a delivery request may be transmitted from the store 47 at the delivery location 49 to the central station 28, to request emergency inventory, and the central station 28 transmits a signal to the mobile unit 16, to re-route the emergency inventory from being delivered to the retail store 45 at the deliver location 46 to being delivered to the retail store 47 at the delivery location 49. Although FIG. 1 illustrates two stores at two respective locations, the embodiments of the present invention may include less or more than two stores at respective delivery locations.

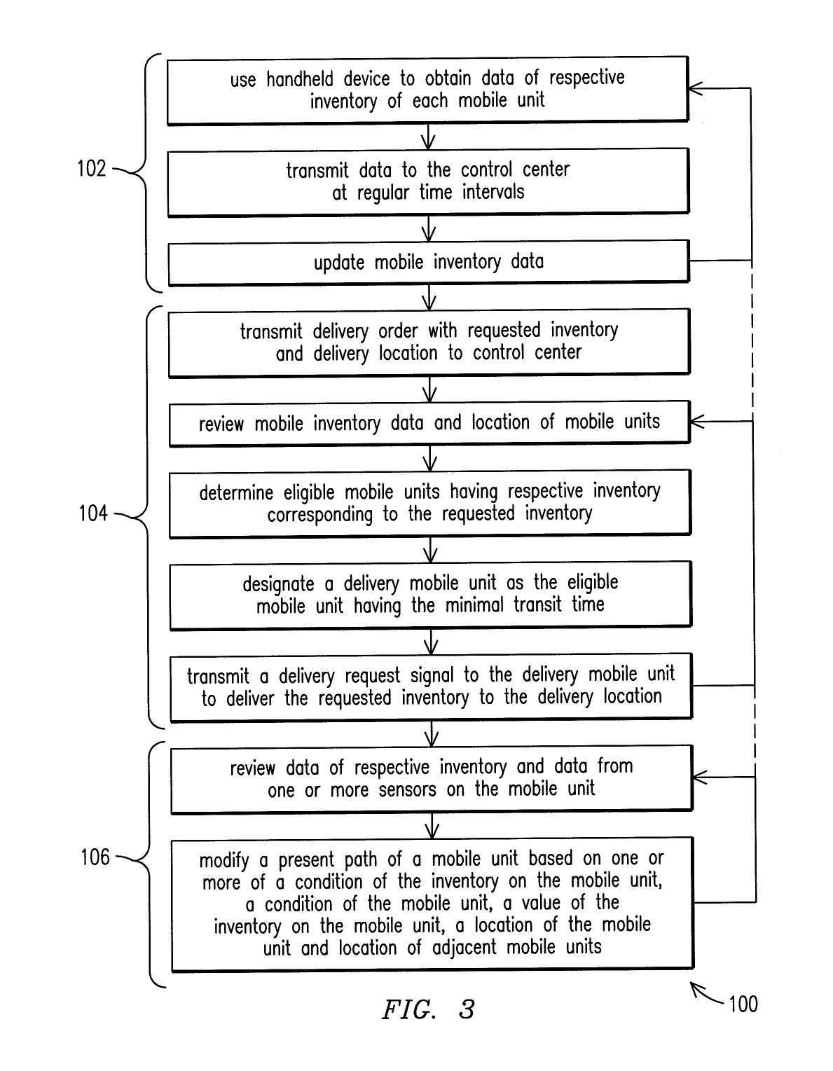

FIG. 3 illustrates a flowchart depicting a method 100 for managing mobile inventory 12 within the virtual warehouse 14, as described in the embodiments illustrated in FIGS. 1-2. The method 100 includes an inventorying 102 phase, in which the data regarding the respective portions 36,38,40 of the mobile inventory 12, the parameters relating to the operation of the mobile units 16,18,20 and/or the location 30,32,34 of the mobile units 16,18,20, are collected and transmitted to the central station 28, on a regular basis, to ensure an updated record for purposes of optimizing the movement of the mobile inventory 12. Although the embodiments of the present invention discuss that the inventorying 102 phase is conducted on an automatic basis at regular time intervals, the inventorying 102 phase may be conducted on an automatic basis using a manual trigger or on a manual input basis. When a delivery request is received at the central station 28, the method 100 enters a delivering 104 phase, in which the requested inventory 50 and delivery location 46 are received at the central station 28; the received data regarding the portions 36,38,40 of the mobile inventory 12 and the locations 30,32,34 of the mobile units 16,18,20 is reviewed by the processor 29; eligible mobile units are determined based on whether the respective portion 36,38,40 of the mobile inventory 12 overlaps with the requested inventory 50; a transit time of each eligible mobile unit to the delivery location 46 is calculated; selection of the eligible mobile unit having the minimal transit time to the delivery location 46 is performed; and a transmission of a delivery request signal to the selected mobile unit, with information regarding the requested inventory 50 and the delivery location 46.

Either in the absence of or during the delivering 104 phase, the method 100 may enter the managing 106 phase, in which the received data from the communication devices 22,24,26 of the respective portions 36,38,40 of the mobile inventory 12, the received data regarding the parameters relating to the operation of the mobile units 16,18,20 and the locations 30,32,34 of the mobile units 16,18,20 is reviewed by the processor 29. Based on this review, the processor 29 may transmit a signal to one of the communication devices 22,24,26, to modify a current path of travel of a mobile unit 16,18,20, based on one or more of a condition of the respective portions 36,38,40; a condition of the mobile units 36,38,40; a value of the respective portions 36,38,40; the locations 30,32,34; and a location of adjacent mobile units.

FIG. 4 illustrates a flowchart depicting a method 200 for managing mobile inventory 12 within the virtual warehouse 14. The method 200 begins at 201 by housing 202 the respective portion 36,38,40 of the mobile inventory 12 within a respective mobile unit among the plurality of mobile units 16,18,20. The method 200 further includes collecting 204 respective data relating to the portion 36,38,40 of the mobile inventory 12 within each mobile unit 16,18,20. The method 200 further includes receiving 206 a delivery request for a requested inventory to a delivery location, and determining 208 a delivery mobile unit among the plurality of mobile units, based on comparing the respective portion of the mobile inventory with the requested inventory and comparing a transit time of each mobile unit to the delivery location, based on the collecting 204 of the respective data, before ending at 209.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for managing mobile inventory within a virtual warehouse, said system comprising:
a plurality of mobile units, each mobile unit configured to house a respective portion of the mobile inventory;
a plurality of units, each unit configured to gather data relating to the respective portion of the mobile inventory;
a plurality of position sensors, each position sensor configured to determine a location of a respective mobile unit;
a plurality of communication devices, each communication device configured to receive the respective data from the respective unit and the respective location from the position sensor; and
a central station in communication with said plurality of communication devices, to receive said respective data and said respective location from the communication devices; said central station being in further communication with a plurality of delivery locations of the mobile inventory, to receive a delivery request from a respective delivery location, said delivery request including data regarding a requested inventory and a requested delivery location; and to determine a movement of said mobile inventory within a service area, based on the received respective data, respective locations of the mobile units, the requested inventory and the delivery request from the respective delivery location.

2. The system of claim 1, wherein said central station is configured to determine the movement of said mobile inventory based on at least one of:
the respective location of each mobile unit; and
the respective portion of the mobile inventory within each mobile unit.

3. The system of claim 2, further comprising a sensor configured to measure a condition of the respective portion of the mobile inventory; wherein said respective data includes data relating to at least one of the measured condition and a cost of the respective portion of the mobile inventory.

4. The system of claim 3, wherein said sensor is one of a temperature, humidity, and vapor sensor.

5. The system of claim 1, wherein each communication device is further configured to collect a respective parameter related to an operation of the mobile unit; said central station is configured to receive said respective parameter and to determine the movement of said mobile inventory based on the received respective parameter.

6. The system of claim 1, wherein upon receiving the delivery request from the respective delivery location for the requested inventory, said central station is configured to determine said movement of the mobile inventory based on at least one of:
the respective portion of the mobile inventory within each mobile unit;
a respective location of each mobile unit;
the requested delivery location; and
the requested inventory.

7. The system of claim 6, wherein said central station is configured to determine said movement of the mobile inventory, by designating a delivery mobile unit among the plurality of mobile units to deliver the requested inventory to the requested delivery location based on:
an overlap comparison between the respective portion of the mobile inventory within the delivery mobile unit and the requested inventory; and
a proximate comparison of the location of the delivery mobile unit and the requested delivery location.

8. The system of claim 7, wherein said overlap comparison is performed to determine whether the requested inventory coincides with the respective portion of the mobile inventory within the delivery mobile unit

9. The system of claim 7, wherein said proximate comparison is based on a determination of a minimal travel time between the location of the delivery mobile unit and the delivery location.

10. The system of claim 1, wherein said communication devices communicate with the central station using at least one of a terrestrial, satellite, and wi-fi network.

11. A system for managing mobile inventory within a virtual warehouse, said system comprising:
at least one mobile unit configured to house a respective portion of the mobile inventory;
at least one unit, each unit configured to gather data relating to the respective portion of the mobile inventory;
at least one position sensor, each position sensor configured to determine a location of a respective mobile unit;
at least one communication device, each communication device configured to collect the respective data and the respective location from the respective unit and position sensor; wherein a movement of said mobile inventory within a service area is determined, based on said respective data and said respective location;
a central station in communication with each communication device, to receive said respective data and said respective location from the at least one communication device; said central station being in further communication with a plurality of delivery locations of the mobile inventory, to receive a delivery request from a respective delivery location, said delivery request including data regarding a requested inventory and a requested delivery location; and to determine a movement of said mobile inventory within a service area, based on the received respective data, respective locations of the at least one mobile unit, the requested inventory and the delivery request from the respective delivery location.

12. The system of claim 11, further comprising a plurality of mobile units, a plurality of communication devices, wherein said central station is configured to determine one or more eligible mobile units such that the respective portion of the mobile inventory includes the requested inventory, and wherein said central station is configured to determine a delivery mobile unit among the eligible mobile units having a minimal transit time to the respective delivery location.

13. The system of claim 12, wherein said central station is configured to optimize the movement of said mobile inventory based on at least one of:
the respective location of each mobile unit; and
said respective portion of the mobile inventory within each mobile unit.

14. The system of claim 11, wherein upon receiving a delivery request from a delivery location for a requested inventory, said central station is configured to optimize said movement of the mobile inventory based on at least one of:
said respective portion of the mobile inventory within each mobile unit;
the respective location of each mobile unit;
the delivery location; and
the requested inventory.

15. The system of claim 12, wherein each communication device is further configured to collect a respective parameter related to an operation of the mobile unit; said central station is configured to receive said respective parameter and to optimize the movement of said mobile inventory based on the received respective parameter.

16. The system of claim 15, wherein upon receiving said respective parameter which exceeds a safety threshold, said central station is configured to transmit a re-routing signal to the respective mobile unit, such that the respective mobile unit is redirected to a proximate destination to transfer the respective portion of the mobile inventory to a secondary mobile unit located at the proximate destination.

17. The system of claim 16, wherein said safety threshold is based on one of a fragility and value of the respective portion of the mobile inventory within the mobile unit.

18. A method for managing mobile inventory within a virtual warehouse, said method comprising:
housing a respective portion of the mobile inventory within a respective mobile unit among a plurality of mobile units;
collecting respective data relating to the portion of the mobile inventory within each mobile unit;
receiving a delivery request for a requested inventory to a delivery location;
determining a delivery mobile unit among the plurality of mobile units, based on comparing the respective portion of the mobile inventory with the requested inventory and comparing a transit time of each mobile unit to the delivery location based on the collecting of the respective data.
